(19) United States
(12) Patent Application Publication
(10) Pub. No.: US 2009/0231106 A1
(43) Pub. Date: Sep. 17, 2009

(54) Tag Apparatus,Transceiver Apparatus, and Tag System

(75) Inventor: Hideto Okamura, Nagano (JP)

Correspondence Address: JORDAN AND HAMBURG LLP, 122 EAST 42ND STREET, SUITE 4000, NEW YORK, NY, 10168, US

(73) Assignee: TOTOKU ELECTRIC CO., LTD., Shinjuku-ku (JP)

(21) Appl. No.: 12/083,295

(22) PCT Filed: Jan. 27, 2006
(86) PCT No.: PCT/JP2006/301281

§ 371 Date: Apr. 8, 2008

(51) Int. Cl. H04Q 5/22

(52) U.S. Cl. 340/10.2

(57) ABSTRACT

A tag apparatus (10) transmits its ID periodically over the wireless at the first frequency. When receiving the ID, a transceiver apparatus (20) notifies an upper hierarchy apparatus (H) of the reception of the ID. The transceiver apparatus (20) when receiving a command from the higher hierarchy apparatus (H), transmits the command over the wireless at the second frequency. Upon receiving the command, the tag apparatus (10) conducts a processing action of a peripheral apparatus (4) determined by the command and transmits a user ID over the wireless at the second frequency. When receiving the user ID, the transceiver apparatus (20) notifies the upper hierarchy apparatus (H) of the reception of the user ID.

### FIELD OF THE INVENTION

The present invention relates to a tag apparatus, a transceiver apparatus, and a tag system and more particularly, to a tag apparatus, a transceiver apparatus, and a tag system which can prevent collisions while driving peripheral devices and notifying of the state of the peripheral devices.

### BACKGROUND OF THE INVENTION

There have been known a tag apparatus of one-way communication type for periodically transmitting over the wireless its ID (a user non-rewritable identification data which has been assigned in advance and inhibited from being rewritten by a user) and a tag apparatus of two-way communication type for transmitting over the wireless its ID or user ID (a user rewritable identification data which can be rewritten partially or entirely by a user) and receiving relevant commands (for example, see Patent Citation 1).

### Patent Citation 1: Japanese Patent Laid-open Publication No. 2005-268837.

### DISCLOSURE OF THE INVENTION

### Problems to be Solved by the Invention

Such a tag apparatus of one-way communication type is not capable of receiving over the wireless a command for driving a peripheral device or notifying of the state of a peripheral device.

On the other hand, such a tag apparatus of two-way communication type has a drawback that its communication time is longer than that of the one-way communication type, whereby the occurrence of collisions will increase as the number of tag apparatuses in a given space is increased thus hardly ensuring the communication over the wireless.

It is hence an object of the present invention to provide a tag apparatus, a transceiver apparatus, and a tag system which can prevent collisions while driving peripheral devices and notifying of the state of the peripheral devices.

### Means for Solving the Problems

As a first aspect, a tag apparatus (10) according to the present invention is provided comprising an RF transmitter (11) for communication at a first frequency, an RF transmitter/receiver (12) for communication at a second frequency, and a data processor (13), wherein the data processor (13) is arranged to periodically transmit an ID from the RF transmitter (11) while receiving a command with and transmitting a user ID from the transmitter/receiver (12).

The tag apparatus (10) of the first aspect allows the RF transmitter (11) to periodically transmit its ID in the one-way communication mode, thus minimizing the communication time, decreasing the occurrence of collisions even when the number of the tag apparatuses (10) in a given space is increased, and ensuring the communication over the wireless. Also, with its RF transmitter/receiver (12) arranged to receive a Command and transmit a user ID in the two-way communication mode, the tag apparatus (10) can drive a peripheral device and notify of the state of the peripheral device. Since the RF transmitter (11) and the RF transmitter/receiver (12) are different from each other in the frequency to be used, their overlapping action will disallow the occurrence of collisions. Moreover, when the number of the two-way communication actions is decreased to a less number than that of the one-way communication actions, the operating life of a built-in battery in the tag apparatus (10) can increase.

As a second aspect, a transceiver apparatus (20) according to the present invention is provided comprising an RF receiver (21) for communication at a first frequency, an RF transmitter/receiver (22) for communication at a second frequency, and a data processor (23), wherein the data processor (23) is arranged to receive an ID with the RF receiver (21) while transmitting a command from and receiving a user ID with the transmitter/receiver (22).

The transceiver apparatus (20) of the second aspect allows the RF receiver (21) to receive the ID from the tag apparatus (10) of the first aspect in the one-way communication mode, thus minimizing the communication time, decreasing the occurrence of collisions even when the number of the tag apparatuses (10) in a given space is increased, and ensuring the communication over the wireless. Also, with its RF transmitter/receiver (22) arranged to transmit a command and receive a user ID in the two-way communication mode, the transceiver apparatus (20) can drive a peripheral device of the tag apparatus (10) and examine the state of the peripheral device. Since the one-way communication mode and the two-way communication mode are different in the frequency to be used, their overlapping action will disallow the occurrence of collisions.

As a third aspect, a tag system (100) according to the present invention is characterized in that the tag apparatus (10), which is defined in claim 1, transmits an ID periodically over the wireless at the first frequency, and the transceiver apparatus (20), which is defined in claim 2, when receiving the ID notifies an up hierarchy apparatus (H) of the reception of the ID and when receiving a command from the higher hierarchy apparatus (H) transmits the command over the wireless at the second frequency, and the tag apparatus (10) when receiving the command conducts a processing action determined by the command.

The tag system (100) of the third aspect allows the ID to be transmitted periodically in the one-way communication mode, thus minimizing the communication time, decreasing the occurrence of collisions even when the number of the tag apparatuses (10) in a given space is increased, and ensuring the communication over the wireless. Also, since the transmission and reception of a command and a user ID is carried out in the two-way communication node, a peripheral device of the tag apparatus (10) can be driven or the state of the peripheral device can be examined. Since the one-way communication mode and the two-way communication mode are different in the frequency to be used, their overlapping action will have no trouble. Moreover, when the number of the two-way communication actions is decreased to a less number than that of the one-way communication actions, the operating life of a built-in battery in the tag apparatus (10) can increase.

According to the tag apparatus, the transceiver apparatus, and the tag system of the present invention, the occurrence of collisions is minimized even when the number of the tag apparatuses in a given space increases, whereby the communication over the wireless will easily be ensured. As the transmission and reception of a command and a user ID is carried out in the two-way communication mode, the peripheral device in the tag apparatus can be driven and their state can be examined. Also, since the one-way communication mode and the two-way communication mode are different in the frequency to be used, their overlapping action will have no trouble. Moreover, when the number of the two-way communication actions is decreased to a less number than that of the one-way communication actions, the operating life of a built-in battery in the tag apparatus can increase.

### BEST MODES FOR EMBODYING THE INVENTION

The present invention will be described in more detail in the form of one preferred embodiment illustrated in the relevant dings. The present invention is not limited to the embodiment.

### Embodiment 1

FIG. 1 is a structural view of a tag apparatus 10 showing Embodiment 1.

The tag apparatus 10 comprises an RF transmitter 11 for communicating at a first frequency f1 (for example, 303.825 MHz), an RF transmitter/receiver 12 for communicating at a second frequency f2 (for example, 315 MHz), a data processor 13, and a peripheral apparatus 4 connected with the data processor 13.

The peripheral apparatus 4 includes operating switches 1, LEDs 2, and a buzzer 3.

FIG. 2 is an external view of the tag apparatus 10.

The operating switches 1, the LEDs 2, and the buzzer 3 are mounted an a case 5.

FIG. 3 is a structural view of a transceiver apparatus 20 showing Embodiment 1.

The transceiver apparatus 20 comprises an RF receiver 21 for communicating at the first frequency f1 (for example, 303.825 MHz), an RF transmitter/receiver 22 for communicating at the second frequency f2 (for example, 315 MHz), and a data processor 23.

The data processor 13 is connected to a higher hierarchy apparatus H such as a host computer.

FIG. 4 illustrates a structural view of a tag system 100 and a timing chart of its one-way communication showing Embodiment 1.

The tag system 100 is composed of a group of the tag apparatuses 10 (only one shown) and the transceiver apparatus 20.

The data processor 13 in the tag apparatus 10 directs the RF transmitter 11 to transmit the ID at equal intervals of time T (for example, five seconds). The RF transmitter 11 transmits the ID over the wireless at the frequency f1.

The ID at the frequency f1 is received by the RF receiver 21 and transferred to the data processor 23 in the transceiver apparatus 20. The data processor 23 notifies the higher hierarchy apparatus H of the reception of the ID.

FIG. 5 is a timing chart of two-way communication in the tag system 100.

The higher hierarchy apparatus H upon being notified of the reception of the ID frau the transceiver apparatus 20 examine whether or not there is a command assigned to the ID and when finding the command, delivers the command to the transceiver apparatus 20.

When receiving the command assigned to the ID from the higher hierarchy apparatus H, the data processor 23 in the transceiver apparatus 20 directs the RF transmitter/receiver 22 to transmit the command over the wireless. The RF transmitter/receiver 22 transmits the command over the wireless at the second frequency f2.

The command at the second frequency f2 is received by the RF transmitter/receiver 12 and transferred to the data processor 13 in the tag apparatus 10. The data processor 13 discards a command which is not assigned to the ID of the tag apparatus 10. When the command is assigned to the ID, the data processor 13 conducts a processing action determined by the command. In case that the processing action involves “notifying of the state of the operating switches 1”, the data processor 13 scans the state of the operating switches 1, writes its scanned data into the user ID, and directs the RF transmitter/receiver 12 to transmit the written user ID. The RF transmitter/receiver 12 transmits the written user ID over the wireless at the frequency f2.

The written user ID at the frequency f2 is received by the RF transceiver/receiver 22 and transferred to the data processor 23 in the transceiver apparatus 20. The data processor 23 notifies the higher hierarchy apparatus H of the reception of the user ID.

The higher hierarchy apparatus H upon being notified of the reception of the user ID from the transceiver apparatus 20 examines whether or not there is a command assigned to the user ID and wen finding the command, delivers the command to the transceiver apparatus 20.

When receiving the command assigned to the user ID from the higher hierarchy apparatus H, the data processor 23 in the transceiver apparatus 20 directs the RF transmitter/receiver 22 to transmit the command aver the wireless. The RF transmitter/receiver 22 transmits the command over the wireless at the second frequency f2.

The command at the second frequency f2 is received by the RF transmitter/receiver 12 and transferred to the data processor 13 in the tag apparatus 10. The data processor 13 discards a command which is not assigned to the ID of the tag apparatus 10. When the command is assigned to the ID, the data processor 13 objects a processing action determined by the command. In case that the processing action involves “illuminating the LED 2 and turning the buzzer 3 on”, the data processor 13 directs the LED 2 to illuminate and the buzzer 3 to emit a sound. The data processor 13 then writes its completion of the action into the user ID and directs the RF transmitter/receiver 12 to transmit the rewritten user ID. The RF transmitter/receiver 12 transmits the rewritten user ID aver the wireless at the frequency f2.

The rewritten user ID at the frequency f2 is received by the RF transceiver/receiver 22 and transferred to the data processor 23 in the transceiver apparatus 20. The data processor 23 notifies the higher hierarchy apparatus H of the reception of the rewritten user ID.

The tag system 100 of Embodiment 1 has the following advantages.

(1) Since the one-way communication is selected for transmitting the ID periodically its consuming time remains short. Even when the number of the tag apparatuses 10 is increased in a given space in the system, the occurrence of collisions will rarely take place thus ensuring the communication over the wireless with much ease.
(2) Since the two-way communication is selected for transmitting and receiving the command and the user ID, it permits the peripheral apparatus 4 to be driven or its state to be examined.
(3) Since the one-way communication and the two-way communication are different from each other in the frequency to be used, their overlapping action will have no trouble.
(4) Since its RF transmitter 11 is activated during the periodical, one-way communication, which is relatively short, and deactivated in the other duration while its RF transmitter/receiver 12 is activated during the two-way communication, which is less frequently carried out than the one-way communication, and deactivated in the other duration, the tag apparatus 10 can be increased in the operating life of its built-in battery.
(5) Since the two-way communication for each ID is carried out just after the one-way communication, the tag apparatus 10 allows the action of its transmitter/receiver 12 to be briefly commenced lust after the one-way communication and continued when the command assigned to its ID or canceled when the commend not assigned to its ID. Accordingly, the tag apparatus 10 can be increased in the operating life of its built-in battery.

Although the action of the transmitter/receiver 12 in the tag apparatus 10 is briefly commenced just after every action of the one-way communication, it may be conducted intermittently (for example, one time in every two actions of the one-way communication) thus to further increase the operating life of the built-in battery of the tag apparatus 10.

### INDUSTRIAL APPLICABILITY

The tag apparatus, the transceiver apparatus, and the tag system according to the present invention are then applicable to an asset retrieving (inventory taking) system, a questionnaire sampling system, or an auctioning system.

### BRIEF DESCRIPTION OF THE DRAWINGS

FIG. 1 is a structural view of a tag apparatus showing Embodiment 1 of the present invention;

FIG. 2 is an external view of the tag apparatus showing Embodiment 1;

FIG. 3 is a structural view of a transceiver apparatus showing Embodiment 1;

FIG. 4 is a timing chart of one-way communication in a tag system showing Embodiment 1; and

FIG. 5 is a timing chart of two-way communication in the tag system showing Embodiment 1.

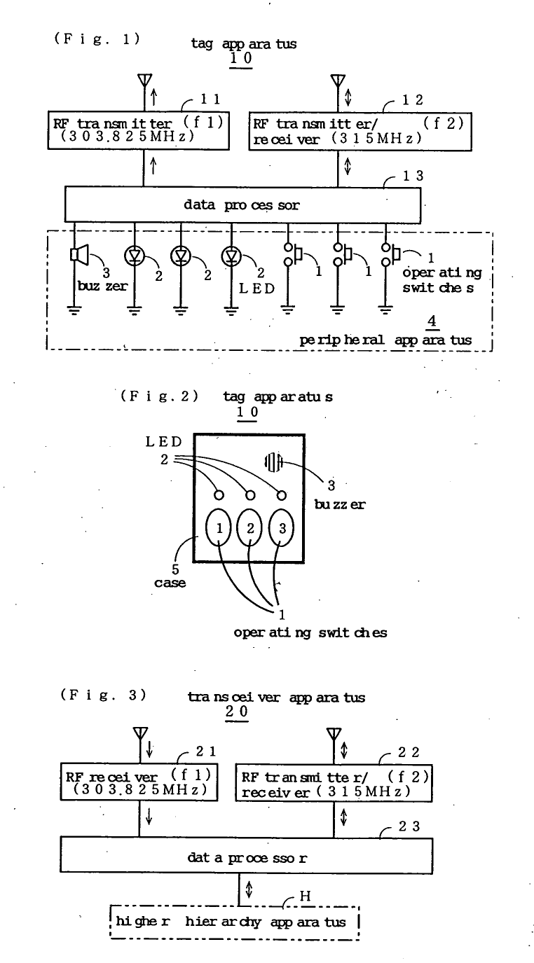

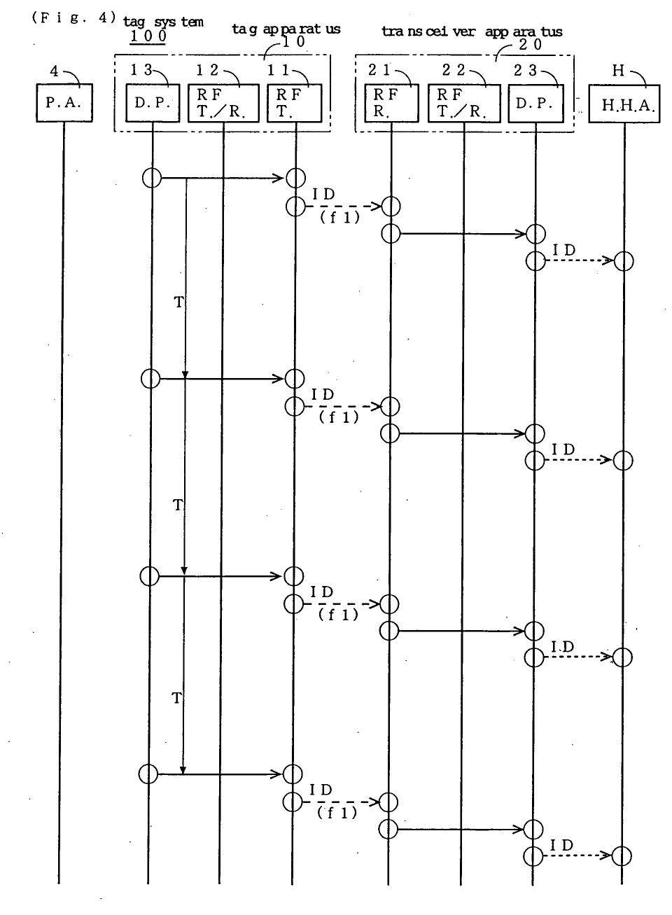

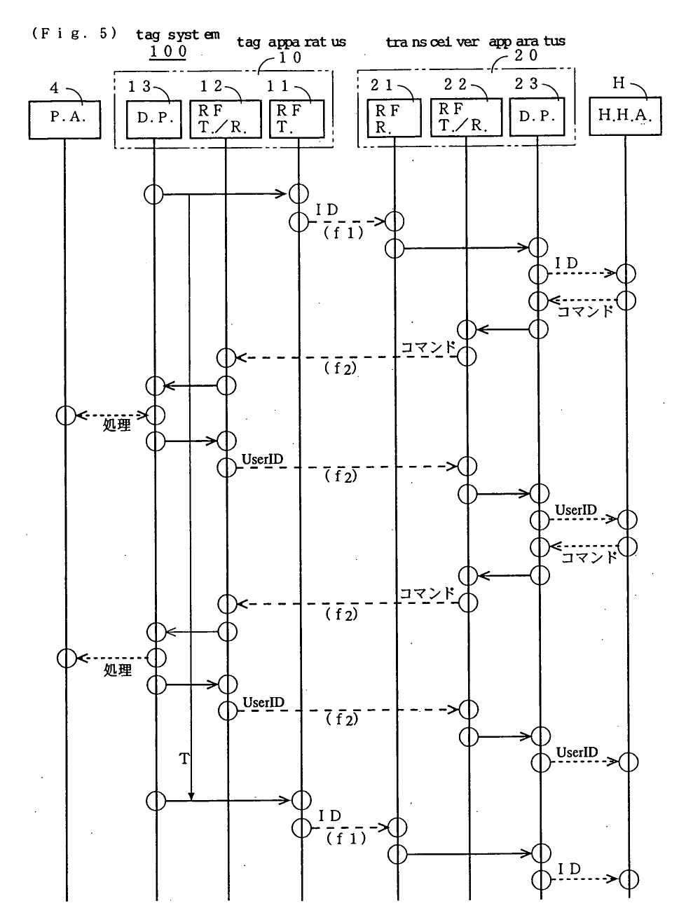

### DESCRIPTION OF THE NUMERALS

4: Peripheral device, 10: Tag apparatus, 11: RF transmitter, 12: RF transmitter/receiver, 13: Data processor, 20: Transceiver apparatus, 21: RF receiver, 22: RF transmitter/receiver, 23: Data processor, 100: Tag system.

What is claimed is:

1. A tag apparatus (10) including an RF transmitter (11) for communication at a first frequency, an RF transmitter/receiver (12) for communication at a second frequency, and a data processor (13), characterized in that the data processor (13) is arranged to periodically transmit an ID from the RF transmitter (11) while receiving a command with and transmitting a user ID from the transmitter/receiver (12).

2. A transceiver apparatus (20) including an RF receiver (21) for communication at a first frequency, an RF transmitter/receiver (22) for communication at a second frequency, and a data processor (23), characterized in that the data processor (23) is arranged to receive an ID with the RF receiver (21) while transmitting a command from and receiving a user ID with the transmitter/receiver (22).

3. A tag system (100) characterized in that the tag apparatus (10), which is defined in claim 1, transmits an ID periodically over the wireless at the first frequency, the transceiver apparatus (20), which is defined in claim 2, when receiving the ID notifies an upper hierarchy apparatus (H) of the reception of the ID, and when receiving a command from the higher hierarchy apparatus (H) transmits the command over the wireless at the second frequency, and the tag apparatus (10) when receiving the command conducts a processing action determined by the command.
